(19) United States
(12) Patent Application Publication
(10) Pub. No.: US 2014/0030485 A1
(43) Pub. Date: Jan. 30, 2014

(54) RENEWABLE PRINT MEDIA

(71) Applicants: John L. Stoffel, San Diego, CA (US); Xulong Fu, San Diego, CA (US); Xiaoqi Zhou, San Diego, CA (US)

(72) Inventors: John L. Stoffel, San Diego, CA (US); Xulong Fu, San Diego, CA (US); Xiaoqi Zhou, San Diego, CA (US)

(21) Appl. No.: 13/560,025

(22) Filed: Jul. 27, 2012

(51) Int. Cl. B32B 27/14; B05D 7/00

(52) U.S. Cl. 428/143; 428/447; 427/407.1

(57) ABSTRACT

The present disclosure is drawn to renewable print media, such as erasable or recyclable print media. In one example, a renewable print medium can comprise a media substrate, a pigmented base applied to the media substrate, and a renewable imaging layer applied to the pigmented base. The renewable imaging layer can comprise pigmented particulates and a polymeric binder, and the renewable imaging layer can comprise a polysiloxane with an unsaturated organic side group, a catalyst, and three-dimensional siloxane.

### BACKGROUND

Traditional print media can include either regular paper that is untreated, or can include a coating printed on one or both sides of a raw base paper. Typically, with respect to print technologies, printing is considered to be a single use or single print proposition. This is because ink or electrostatic printing toner is unlike pencil lead or other erasable materials and cannot be readily removed from the print media after application. For example, with electro-photographic printing, toner is applied to a print media substrate and typically fused thereon with heat. Fused toner typically adheres well to various types of media, and thus the rubbing action of an eraser or scraper is not typically adapted well for removal of the printed image without damaging the print media.

Thus, it would be desirable to provide technology that allows for erasability of digitally printed images either for media reuse, or to provide removability in preparation for paper recycling.

### BRIEF DESCRIPTION OF THE DRAWINGS

FIG. 1 is a schematic drawing a renewable print medium prepared in accordance with examples of the present disclosure; and

FIG. 2 is a flow diagram of a method of preparing a renewable print medium in accordance with examples of the present disclosure.

### DETAILED DESCRIPTION

In accordance with this, the present disclosure is directed generally towards print media for electro-photographic printing, such as LaserJet media, having a renewable imaging layer coated thereon which can provide for controllable toner adhesion when printing with a LaserJet printer. A renewable imaging layer, for example, can provide several advantages, including providing an erasable surface for laser printing (for reuse), or alternatively, providing easy removal of a toner printed layer during the media recycling process. Thus, renewable media can provide a reduced environmental impact as well as provide cost savings for customers who wish to erase printed matter and recycle the media for further use.

In accordance with this, the present disclosure is drawn to a renewable print medium comprising a media substrate, a pigmented coating applied to the media substrate, and a renewable imaging layer applied to the pigmented base. The pigmented base can comprise pigmented particulates and a polymeric binder. It is noted that the pigmented base can be applied as a single layer, or as multiple layers. The renewable imaging layer can comprise a polysiloxane with an unsaturated organic side group, a catalyst, and three-dimensional siloxane.

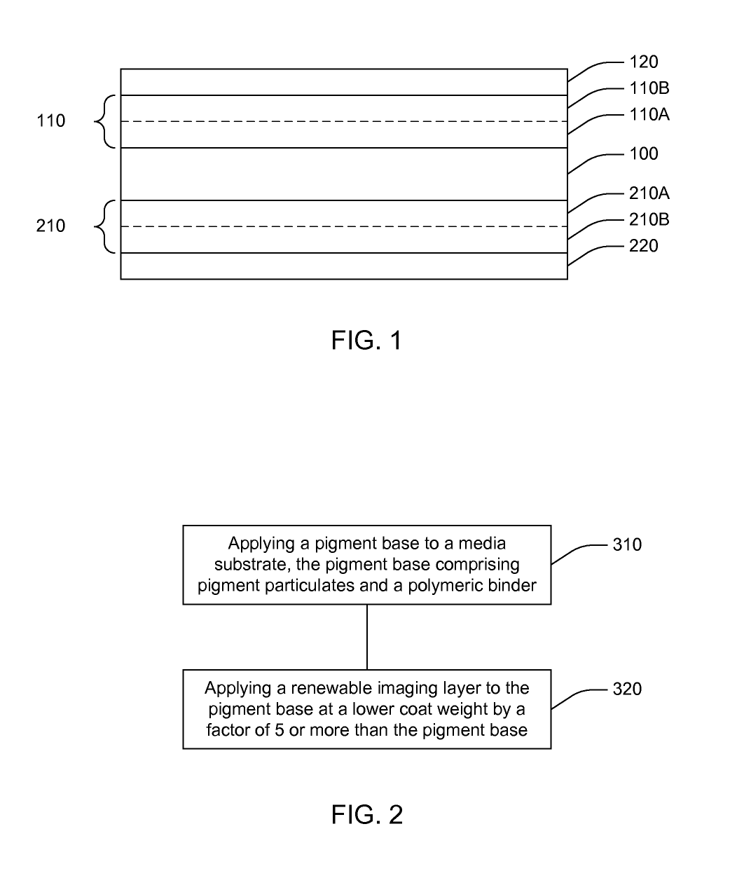

Turning now to specific examples of the renewable print media of the present disclosure, FIG. 1 sets forth print media that can be prepared. Specifically, in FIG. 1, the renewable print media comprises a media substrate 100, which can be raw base paper or other suitable substrate that will adhere to the layers coated thereon, for example. Coated on the media substrate is pigmented base 110, which can be a single layer or include multiple pigmented layers. If multiple layers are used, in one arrangement, a pigmented undercoat 110A and a pigmented topcoat 1108 can be present. The pigmented base can be calendared to enhance the smoothness of the pigmented base, if desired. Applied to the pigmented base 110 is a renewable image receiving layer 120 which comprises a polysiloxane with an unsaturated organic side group, a catalyst, and three-dimensional siloxane, which will be described in greater detail hereinafter. Optionally, the same coatings or different coatings can be applied to the backside of the print media. If the paper is intended to be printable and erasable on both sides, for example, then the backside can likewise include a pigmented base 210 (optionally including multiple layers of the pigmented base 210A, 210B), and a renewable image receiving layer 220 as well. If the backside is not intended to be printable and erasable, then the backside can remain uncoated, or coated with a backing formulation to balance out the curl or provide other functional features generated by the topcoating layers.

In another example, a method of preparing a renewable print medium, as shown generally in FIG. 2, can comprise applying 310 a pigmented base including pigment particulates and a polymeric binder to a media substrate. Additionally, the method further comprises applying 320 a renewable imaging layer to the pigmented base at a lower coat weight by a factor of 5 or more than the pigmented base. Typically, the smoothness of the print medium is enhanced when the renewable imaging layer is applied to the pigmented base.

It is noted that when discussing the present renewable print media, coating compositions used to prepare the print media, and related methods, each of these discussions can be considered applicable to each of these embodiments, whether or not they are explicitly discussed in the context of that embodiment. Thus, for example, in discussing renewable print media, any coating described therewith can also be used in the method thereof, and vice versa. Furthermore, it is noted that the print media described herein is referred to generally as “renewable” print media. The term “renewable” thus refers to the media that is erasable, recyclable, or otherwise modifiable to remove printed laser images.

Referring now to the media substrate 100, cellulose fiber based paper or raw base paper are typical substrates, though plastics, metals, or other substrates can also be used. The raw base paper can be synthetic or natural paper, and can be recycled or regenerated as well. Regarding raw base paper specifically, this substrate can comprise wood fiber such as softwood, hardwood, and/or recycles fibers. In one example, the raw base can include a mineral filler such as Precipitated Calcium Carbonate (PCC) and/or Ground Calcium Carbonate (GCC), to name a few. In one example, the raw base paper can be surface sized, and in another example, the raw base paper can be surface pigmented (in addition to the pigmented base described hereinafter). Further, the raw base paper can include internal sizing material, retention aids, optical brighteners (OBA), dyestuffs, and/or other wet end chemicals, to name a few. A typical weight for the raw base paper (or other substrate) can be from 40 gsm to 300 gsm, though weights outside of this range can also be used. It is noted, however, that because multiple coating layers are applied to the raw base paper substrate, strictly speaking, high levels of whiteness or brightness of the base paper is not necessary.

Turning now more specifically to the pigmented base, as mentioned, this can be a single unitary layer 110, or multiple layers 110A, 110B. In the latter example, the pigmented layer can include an undercoat 110A and a top coat layer 110B. The pigmented layer(s) 210, 210A, 210B can also be on the backside of the erasable print media. Regardless of the specific configuration of the pigmented layer(s), in one example, from 60 wt % to 90 wt % pigments can be present in the layer as a whole. Exemplary pigments that can be used include Ground Calcium Carbonates (GCC), Precipitated Calcium Carbonates (PCC), Clays, plastic pigments, and titanium dioxide. The pigments are typically held together in a coating composition (and once formed on the substrate) using a polymeric binder. The binder can be water soluble or water dispersible, and examples include styrene butadiene latex, styrene acrylic, dextrin, starch, polyvinyl alcohol, combinations thereof, or the like. Additional additives can also optionally be included, such as slip aids, deformers, optical brightening agents (OBA), dyestuffs, surfactants, rheological modifiers, cross-linkers, dispersing agents, and/or resistivity control agents, to name a few. The coat weight for pigmented layer is typically greater than the renewable imaging layer. In one example, the coat weight can be 2 gsm to 40 gsm, thought coat weights outside of this range can also be acceptable.

Referring now specifically to the renewable image receiving layer 120, or layers 120, 220, compounds that can be present in this layer include a polysiloxane with an unsaturated organic side group, a catalyst, and three-dimensional siloxane. Specifically, the polysiloxane with an unsaturated organic side group, the catalyst, and the three-dimensional siloxane can be formulated to lessen intermolecular interactions between the image receiving layer as a whole and fused toner that is applied thereto during the printing process. This can be accomplished by modifying the traditional chemical reaction, interdiffusion, electrostatic attraction, surface energetic, and/or wettability across this interface that is typically present between a fused toner and a typical paper media at their interface.

Thus, the renewable image receiving layer provides a toner/media interface where fused toner particles transferred from an OPC (Organic PhotoConductor), or other intermediate drum or plate, to the renewable image receiving layer in such a way that the toner can be easily removed by an mechanical rubbing or scraping without damaging other layers of the renewable print media. More specifically, the toner particles can be fused on the media and form an interface with good adhesion that provides for the printed image being unerasable under normal use condition (stacking, handling, etc.), but erasable when rubbed or scraped with moderate pressure, e.g., from slightly more to slightly less than the pressure used to erase a pencil marking on paper with a rubber eraser. For example, if a user desires to reuse the renewable print media for printing a new image, the user can apply moderate pressure and rubbing action with a rubber eraser or metal scrapper to remove the prior image, and the renewable image receiving layer will now be in a condition to receive the new image on the renewed (erased) renewable image receiving layer. Appropriate pressures that can be used to achieve this erasing property can be from about 0.4 to 0.8 psi while rubbing a standard eraser or scraper over the printed image. Pressures less than about 0.2 psi would not be expected to substantially remove the printed image, as such pressures would be considered to be within standard pressures applied to printed media during normal use (paper stacking, sliding paper together in stacks, running the hand over the printed media, etc.). Furthermore, pressures greater than about 1.0 psi would be expected to be too great, as such pressures would likely damage the renewable print media in a manner to cause it not be reusable. Heavier pressures may, however, be acceptable if the goal is simply to remove the printed and fused toner for recycling (where damaging the print media is not necessarily a problem).

With specific reference to the polysiloxane, the catalyst, and the three-dimensional siloxane of the renewable imaging layer, it is notable that these ingredients can be separate components, or in some cases, can be part of a common system. Furthermore, certain ingredients can be part of a copolymer. For example, the polysiloxane can be in the form of a monomer or a polymer, such as a vinyl polysiloxane copolymer. In certain examples, the polysiloxane includes multiple central silicon (Si) atoms with from 1 to 3 methylene or ethylene groups, and one or two unsaturated organic side groups, such as one or two vinyl groups. The silicon atoms can be bonded together with oxygen atoms. A more specific example of a polysiloxane that can be used includes copolymers of methylvinylsiloxane-dimethylsiloxane, which also comprises polymethyl-hydrogensiloxane.

The renewable imaging layer also includes a catalyst as part of a system, which can be a metal containing catalyst, such as platinum catalyst. The catalyst can be formulated or configured to interact with the polysiloxane by initiating and accelerating a reaction at the unsaturated organic side group. Thus, the catalyst can open the unsaturated bond in the side group of the polysiloxane and a polymerization reaction can be initiated.

Furthermore, as noted, the renewable imaging layer can also include a three-dimensional siloxane with multiple central silicon atoms. This three-dimensional siloxane can be used to alter or expand the structure and nature of the polysiloxane when the unsaturated organic side group is opened and by the catalyst and begins to polymerize. The three-dimensional siloxane is referred to as such because it includes several hydrogen atoms present on the compound at many sterically diverse locations, thus providing the enhanced expansion of the polysiloxane during polymerization. Without being bound by any particular theory, by adjusting the amount of the three dimensional siloxane, the molecular interaction between toner particles and receiving media is controlled via both chemical and steric or spacial effects. Examples of three-dimensional siloxanes that can be used are represented in Formula I, as follows:

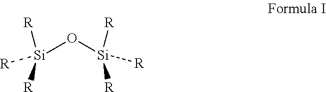

where each R is independently H or C₁ to C₄ lower alkyl. Typically, there are least two C₁ to C₄ lower alkyl groups present, but 4 or 6 C₁ to C₄ lower alkyl can also be used. In one specific example, the three-dimensional siloxane can be bis(trimethylsilyl)oxide, which has 18 sterically diversely positioned hydrogen atoms, as shown in Formula II, as follows:

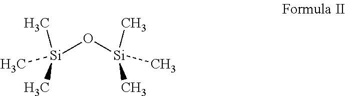

In further detail regarding the renewable imaging layer, the polysiloxane, the catalyst, and the three-dimensional siloxanes described above can be present in a water bone emulsion system, forming nano-scale particles which are then emulsified into an aqueous dispersion, e.g., 20 wt % to 50 wt % solids. This type of system allows for simple dilution by merely adding additional water for specific coating applications. In such systems, an additional polymer with a micro-crystalline structure can be added therewith to control surface smoothness and the coefficient of friction. Examples of such additives include polyethylene or Paraffin wax emulsion with micro-crystalline structure. Other additives that can be used will be described hereinafter.

In another example, an organic liquid can be used as the carrier, provided the organic liquid is compatible with the polysiloxane, catalyst, and three-dimensional siloxanes. Typically, high molecular weight polysiloxanes and catalyst can co-existing and diluted in volatile organic solvents, e.g., solvents having a flash point below about 4 to 60° C. Solvent systems can also be selected that provide high clarity filmic liners, and low adhesion force to toner particles. Examples of appropriate organic solvents can include methylhexane, n-heptane, methylheptane, dimethylhexane, dimethyl cyclopentane, n-hexane, methyl pentane, and/or toluene.

As mentioned, other additives, such as additives to improve smoothness or additional adhesion controlling additives can also optionally be added. Examples of such compounds include polymers or oligomers of fluorine containing compounds, including but not limited to, poly(vinyl fluoride), polytetrafluoroethylene, poly(vinylidene fluoride), poly(methylnonafluorohexylsiloxane), poly(methylnonafluorohexylsiloxane), poly(pentadecafluorooctyl methacrylate), n-perfluoroeicosane, monohydroperfluoroundecanoic acid monolayer, perfluorolauric acid monolayer, and combinations thereof. Other adhesion controlling compounds that are effective include long-chain alkyl derivatives which can achieve a methyl-rich surface by alignment of the alkyl chains on the surface. Examples of such compounds include dispersions of wax-like compounds, such as polyethylene wax, polypropylene wax, polyolefin wax, paraffin wax, Carnauba wax, and combinations thereof. Still other examples of adhesion controlling compounds include metallic salts of fatty acids, such as zinc octadecanoate, calcium octadecanoate, magnesium octadecanoate, chromium octadecanoate, and combinations thereof. Additional adhesion controlling compounds can include polymers which can form a network on the media surface, such as polydimethylsiloxane (PDMS) network. In certain examples, micro particles of microcrystalline wax or inorganic fillers (e.g., hydrophobic silica) can be admixed in the renewable imaging layer to modulate the strength of the adhesiveness of the renewable imaging layer. Additional additives can also be included, such as slip aids, deformers, optical brightening agents (OBA), dyestuffs, surfactants, rheological modifiers, cross-linkers, dispersing agents, and/or resistivity control agents, to name a few.

It is noted that the choice of specific compounds for use in the renewable imaging layer is not the only consideration, as these compounds should be formulated in a composition that provides a desired adhesive interface between the renewable image layer and the fused toner. Thus, concentrations as well as the choice of ingredients can considered to achieve acceptably fixed images (under normal use conditions) that are also renewable (e.g., erasable or otherwise removable under removal conditions without completely removing the renewable imaging layer). Stated another way, the addition of too strong of a specific renewable compound at too high of a concentration may cause poor toner adhesion and subsequently contribute to printing defects, such toner drop-off. Conversely, too week of a renewable compound at too low of a concentration in the renewable imaging layer may cause difficulties in erasing or removal efforts, i.e. causing erasing forces needed to remove the fused toner to be too great to avoid damaging the renewable print media as whole.

Typically, the renewable imaging layer can be prepared as a coating composition that is applied to the pigmented base. The desired coat weight for application can be from 0.1 gsm to 1gsm, though coat weights outside of this range can also be used, depending on the desired application. Such thin, uniform layers of the renewable imaging layer(s) can be obtained due to the presence of the pigmented base applied to the media substrate. This is more particularly the case when the pigmented base is calendared so that it is smooth. In one example, a desired smoothness of the pigmented base or the resultant print media on the renewable imaging layer, as measured by the Park Print Surface method (PPS) per Tappi method 555, can be less than 2 microns, and in another example, can be less than 1 micron. As mentioned previously, the pigmented base can also be present on a backside of the erasable print media, as can the renewable image receiving layer, though this is not required. With respect to application of the coating compositions to form the pigmented base and/or the renewable imaging layer, examples of suitable coating techniques including slotted die application, roller application, fountain curtain application, blade application, rod application, air knife application, gravure application, air brush application, and others known in the arts. Furthermore, when calendaring, any appropriate device can be used, such as super calendaring machine, an on-line soft nip calendaring unit, an off-line soft nip calendaring machine, or the like. Suitable calendaring temperatures can be 50° C. to 90° C., for example.

### EXAMPLES

The following examples illustrate some embodiments of the print media and methods that are presently known. However, it is to be understood that the following are only exemplary or illustrative of the application of the principles of the present compositions and methods. Numerous modifications and alternative compositions and methods may be devised by those skilled in the art without departing from the spirit and scope of the present compositions and methods. The appended claims are intended to cover such modifications and arrangements. Thus, while the present print media and methods have been described above with particularity, the following examples provide further detail in connection with what are presently deemed to be the acceptable embodiments.

### Example 1-3

### Preparation of Base Coating Compositions

Three base coating compositions were prepared in accordance with examples of the present disclosure, as set forth in Table 1 below.

TABLE 1

| | Example 1 | Example 2 | Example 3 |
|---|---|---|---|
| Covergloss | 70 | | |
| (pigment) | | | |
| Hydrocarb H60 | 30 | 30 | 40 |
| (pigment) | | | |
| Ansilex 93 | | | 60 |
| (calcinated | | | |
| pigment) | | | |
| Opcarb A40 | | 70 | |
| (aragonite pigment) | | | |
| Rovene 4040 | 15 | 15 | 15 |
| (non-carboxylated | | | |
| styrene-butadiene | | | |
| latex emulsion) | | | |
| Foamaster VF | 0.5 | 0.5 | 0.5 |
| (defoamer) | | | |
| Mowiol 6-98 | 3 | 3 | 3 |
| (polyvinyl alcohol) | | | |

In each of the above Examples, a pigment slurry was first prepared and mixed with a certain amount of water with defoamer (Foamaster VF), followed by a polyvinyl alcohol (Mowiol 6-98) solution and binder latex (Rovene 4040). The mixing was carried out on a regular low shear bench mixer agitating at 500-800 rpm. The pigmented mixture was then coated on a base substrate using a pilot blade coater at a coating weight of about 15 gsm. The coated paper was then calendared at 3000 pound per square inch (psi) at a temperature of 60° C.

### Example 4

### Preparation of Solvent-Based Renewable Imaging Layer Coating Composition

The coating composition of Table 2 below was coated using a rod metering method on the pigmented bases described in Examples 1-3.

TABLE 2

| | | Amount |
|---|---|---|
| Ingredients | Description | (parts by weight) |
| Silcolease 7460 | Vinylic polyorganosiloxane | 1 |
| (Bluestar) | copolymer | |
| Silcolease 93B | Pt catalyst | 0.012 |
| (Bluestar) | | |
| Silcolease RCA | 3-D siloxane | 0.015 |
| (Bluestar) | | |
| Methylhexane | Solvent | 25 |
| (Aldrich) | | |
| | Coat weight | 0.3 gsm |

### Example 5

### Preparation of Solvent-Based Renewable Imaging Layer Coating Composition

The coating composition of Table 3 below was coated using a rod metering method on the pigmented base described in Example 1.

TABLE 3

| | | Amount |
|---|---|---|
| Ingredients | Description | (parts by weight) |
| Silcolease 7460 | Vinylic polyorganosiloxane | 1 |
| (Bluestar) | copolymer | |
| Silcolease 93B | Pt catalyst | 0.012 |
| (Bluestar) | | |
| Silcolease RCA | 3-D siloxane | 0.015 |
| (Bluestar) | | |
| Methylhexane | Solvent | 25 |
| (Aldrich) | | |
| | Coat weight | 0.65 gsm |

### Example 6

### Preparation of Solvent-Based Renewable Imaging Layer Coating Composition

The coating composition of Table 4 below was coated using a rod metering method on the pigmented base described in Example 1.

TABLE 4

| | | Amount |
|---|---|---|
| Ingredients | Description | (parts by weight) |
| Silcolease PSA 7465 | Vinylic polyorganosiloxane | 1 |
| (Bluestar) | copolymer | |
| Silcolease 93B | Pt catalyst | 0.012 |
| (Bluestar) | | |
| Silcolease ADD 381 | 3-D siloxane | 0.01 |
| (Bluestar) | | |
| Methylhexane (Aldrich) | Solvent | 25 |
| | Coat weight | 0.6 gsm |

### Example 7

### Preparation of Aqueous-Based Renewable Imaging Layer Coating Composition

The coating composition of Table 5 below was coated using a rod metering method on the pigmented base described in Example 1.

TABLE 5

| | | Amount |
|---|---|---|
| Ingredients | Description | (parts by weight) |
| Silcolease emulsion 912 | Base polyorganosiloxane | 100 |
| (Bluestar) | | |
| Silcolease CATA 911 | Pt catalyst | 20 |
| (Bluestar) | | |
| Silcolease RCA 945 | 3-D polyorganosiloxane | 15 |
| (Bluestar) | | |
| Silcolease emulsion XL969 | Crosslinker | 30 |
| (Bluestar) | | |
| | Coat weight | 0.6 gsm |

### Example 8

### Preparation of Aqueous-Based Renewable Imaging Layer Coating Composition

The coating composition of Table 6 below was coated using the rod metering method on the pigmented base described in Example 1.

TABLE 6

| | | Amount |
|---|---|---|
| Ingredients | Description | (parts by weight) |
| Silcolease emulsion 912 | Base polyorganosiloxane | 100 |
| (Bluestar) | | |
| Silcolease CATA 911 | Pt catalyst | 20 |
| (Bluestar) | | |
| Silcolease RCA 945 | 3-D polyorganosiloxane | 15 |
| (Bluestar) | | |
| Silcolease emulsion XL969 | Crosslinker | 30 |
| (Bluestar) | | |
| Ultralube MD-2100 (Keim | Wax | 5.5 |
| Additec Surface GmbH) | | |
| | Coat weight | 0.6 gsm |

### Example 9

### Comparative Testing

A media sheet prepared in accordance with Example 1 having a surface roughness of 1.05 μm was printed with multiple colors for comparative purposes. Specifically, for each color (Cyan, Magenta, Yellow, Black, Red, Green, Blue, and White), a solid density plot at 100% was printed using an HP Color Laser Jet 4700. Each printed sample was measured for Optical Density using an X-Rite 939 device. Next, each printed sample was “erased” with a patch of Galvanized POT Scrubber for 50 passes at maximum pressure that did not damage to the media sheet, e.g., without tearing or ripping the media. After the scrubbing/erasing was complete, the Optical Density was re-measured at the same location using an X-Rite. The data for this erasing control test is provided in Table 7, as follows:

TABLE 7
Control Sample Optical Density (OD) Comparison

Control Sample

| HP Color | OD Before | OD After |
|---|---|---|
| Laser Jet 4700 | OD | OD |
| Cyan | 1.145 | 1.167 |
| Magenta | 1.118 | 0.735 |
| Yellow | 1.459 | 1.486 |
| Black | 1.608 | 1.508 |
| Red | 1.276 | 1.184 |
| Green | 1.266 | 1.111 |
| Blue | 1.524 | 1.096 |
| White | 0.073 | 0.073 |

Likewise, a media sheet prepared in accordance with Example 5 having a surface roughness of 0.80 μm, was printed with multiple colors. It is noted that the surface roughness was lower (smoother) in this example because the thin renewable imaging layer coating provided slightly smoother surface that the pigmented base. Specifically, for each color (Cyan, Magenta, Yellow, Black, Red, Green, Blue, and White), a solid density plot at 100% was printed using an HP Color Laser Jet 4700. Each printed sample was measured for Optical Density using an X-Rite 939 device. Next, each printed sample was “erased” with a patch of Galvanized POT Scrubber for 50 passes at maximum pressure without causing damage to the media sheet, e.g., without tearing or ripping of the media. After the scrubbing/erasing was complete, the Optical Density was re-measured at the same location using the X-Rite device. The data for this erasing control test is provided in Table 8, as follows:

TABLE 8
Treated Sample Optical Density (OD) Comparison

| | |
|---|---|
| HP Color | Treated Sample |

| Laser Jet 4700 | OD Before | OD After |
|---|---|---|
| Cyan | 1.023 | 0.103 |
| Magenta | 1.011 | 0.112 |
| Yellow | 1.499 | 0.217 |
| Black | 1.61 | 0.115 |
| Red | 1.149 | 0.177 |
| Green | 1.058 | 0.21 |
| Blue | 1.421 | 0.102 |
| White | 0.081 | 0.081 |

As can be seen by comparing Tables 7 and 8, after treating the media sheet of Example 1 with the renewable imaging layer coating composition as described in Example 5, the erasability of the LaserJet printing samples was much greater. Specifically, rather than erasability being marginal, as shown in Table 7, the erasability was significantly improved up to and sometimes exceeding a full order of magnitude of OD reduction.

While the disclosure has been described with reference to certain embodiments, those skilled in the art will appreciate that various modifications, changes, omissions, and substitutions can be made without departing from the spirit of the disclosure. It is intended, therefore, that the present disclosure be limited only by the scope of the following claims.

What is claimed is:

1. A renewable print medium, comprising:
a media substrate;
a pigmented base applied to the media substrate, the pigmented base comprising pigmented particulates and a polymeric binder; and
a renewable imaging layer applied to the pigmented base, the renewable imaging layer comprising a polysiloxane with an unsaturated organic side group, a catalyst, and three-dimensional siloxane.

2. The renewable print medium of claim 1, wherein the pigmented particulates are selected from the group of ground calcium carbonate (GCC), precipitated calcium carbonate (PCC), clay, plastic pigmented, titanium dioxide, and mixtures thereof.

3. The renewable print medium of claim 1, wherein the pigmented base is calendared under heat and pressure to a smoothness of 2 microns or less.

4. The renewable print medium of claim 1, wherein the polysiloxane is a vinyl polysiloxane copolymer.

5. The renewable print medium of claim 1, wherein the catalyst is configured to interact with the polysiloxane by initiating and accelerating a reaction at the unsaturated organic side group.

6. The renewable print medium of claim 1, wherein the three-dimensional siloxane has the general structure: 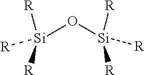
where each R is independently H or C₁ to C₄ lower alkyl.

7. The renewable print medium of claim 6, wherein the three-dimensional siloxane has the general structure:

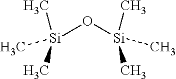

8. The renewable print medium of claim 1, wherein the pigmented base is from 5 gsm to 40 gsm, and the renewable imaging layer is from 0.1 gsm to 1 gsm.

9. The renewable print medium of claim 1, further comprising a backside base applied to a backside of the media substrate, and a backside renewable imaging layer applied to the backside pigmented base.

10. A method of preparing a renewable print medium, comprising:
applying a pigmented base to a media substrate, the pigmented base comprising pigmented particulates and a polymeric binder; and
applying a renewable imaging layer to the pigmented base at a lower coat weight by a factor of 5 or more than the pigmented base.

11. The method of claim 10, further comprising the step of calendaring the pigmented base to a smoothness of 2 microns or less prior to applying the renewable imaging layer.

12. The method of claim 10, wherein the renewable print medium is dried to produce a smooth renewable imaging layer that is erasable using a rubber eraser under rubbing pressure from 0.4 psi to 0.8 psi, but is not erasable at rubbing pressures less than 0.2 psi.

13. The method of claim 10, wherein the pigmented base is applied at a coat weight from 5 gsm to 40 gsm, and the renewable imaging layer is applied to a coat weight from 0.1 gsm to 1 gsm.

14. The method of claim 10, further comprising applying a backside pigmented base to a backside of the media substrate, and applying a backside renewable imaging layer to the backside pigmented base.

15. The method of claim 10, wherein the pigmented base comprises a binder and a pigmented, and the renewable imaging layer comprises microparticles of microcrystalline wax or inorganic filler particles and an adhesion controlling compound.
